(19) United States
(12) Patent Application Publication
(10) Pub. No.: US 2023/0273079 A1
(43) Pub. Date: Aug. 31, 2023

(54) TEST BODY EQUIPPED WITH AN ENCODER

(71) Applicant: NTN-SNR ROULEMENTS, Annecy (FR)

(72) Inventors: Cécile Flammier, Annecy-Le-Vieux (FR); Christophe Duret, Bluffy (FR)

(21) Appl. No.: 18/112,488

(22) Filed: Feb. 21, 2023

(30) Foreign Application Priority Data
Feb. 25, 2022 (FR) 22 01675

(51) Int. Cl. G01L 3/10; G01D 5/14

(52) U.S. Cl. CPC G01L 3/104; G01D 5/145

(57) ABSTRACT

A test body for a system for determining a torque applied between two rotating members, the test body having an internal bushing and an external bushing connected by a deformable structure which is arranged so as to transmit the torque between the members while enabling an angular displacement between the bushings according to the applied torque, the test body being equipped with two rings each carrying a magnetic track which is able to emit a signal representative of the rotational movement of the ring, the rings being fastened respectively on one bushing and the magnetic tracks being magnetized concentrically so that they have a common axis of revolution so as to respectively form an internal magnetic track and an external magnetic track of an encoder.

### BACKGROUND

The invention relates to a test body equipped with an encoder, a method for making such a test body and a system for determining a torque comprising such a test body.

In particular, the invention applies to the determination of a torque applied between two members rotating about a geometric axis of rotation, in particular two members integrated in a transmission of a motor torque to a vehicle, for example between the electric motor and the mechanical transmission of an electrically power assisted bicycle.

For this purpose, it is known to use a test body having an internal bushing secured in rotation with means for mounting said body on one member, and an external bushing extending around the internal bushing while having means for mounting said test body on the other member, said bushings being connected by a deformable structure which is arranged to transmit the torque between the members while enabling an angular displacement between said bushings according to the torque applied between the members.

Such a test body may be instrumented with an encoder of a system for determining the torque comprising a sensor for measuring the angular displacement between the bushings.

Moreover, an encoder is known comprising two rings each carrying a magnetic track able to emit a signal representative of the rotational movement of the corresponding ring, the torque determination system then comprising a sensor having two patterns of sensitive elements disposed at a reading distance respectively from one track to form a signal representative of the angular position of the corresponding ring.

The document FR-2 821 931 describes the use of a device for comparing such signals which is able to determine an angle of relative displacement of the bushings, and therefore the applied torque as it induces said angle.

The limitation of this solution lies in the accuracy of the determination of the torque, in that the magnetic tracks may have eccentricity defects with respect to the geometric axis of rotation, in particular of two different kinds:
a magnetic eccentricity induced by a distance between the centre of the magnetic tracks and the geometric axis of rotation of the part; and
a mechanical eccentricity induced by a distance between the centre of the rings and the geometric axis of rotation;
said defects could cause an error when comparing the position signals, in particular with regards to the determination of reduced torsion angles.

### SUMMARY OF THE DISCLOSURE

The invention aims to solve the problems of the prior art in particular by providing a test body equipped with an encoder comprising two rings each carrying a magnetic track whose possible eccentricity defects still do not affect the accuracy of the determination of a torque.

To this end, according to a first aspect, the invention provides a test body for a system for determining a torque applied between two members rotating about a geometric axis of rotation, said test body having an internal bushing secured in rotation with means for mounting said test body on one member, and an external bushing extending around the internal bushing while having means for mounting said test body on the other member, said bushings being connected by a deformable structure which is arranged so as to transmit the torque between the members while enabling an angular displacement between said bushings according to the torque applied between said members, said test body being equipped with two rings each carrying a magnetic track which is able to emit a signal representative of the rotational movement of said ring, the rings being fastened respectively on one bushing and the magnetic tracks being magnetised concentrically so that they have a common axis of revolution so as to respectively form an internal magnetic track and an external magnetic track of an encoder.

According to a second aspect, the invention provides a method for making such a test body, said method providing for fastening the rings respectively on one bushing, then magnetising each of the magnetic tracks concentrically so that they have a common axis of revolution.

According to a third aspect, the invention provides a system for determining a torque applied between two rotating members about a geometric axis of rotation, said system comprising a test body according to the second aspect and a sensor comprising a first—respectively a second—pattern of sensitive elements disposed at a reading distance from the internal track—respectively from the external track—to form a signal representative of the angular position of the corresponding ring, said system further comprising a device for comparing the signals delivered by the sensor, said device being able to determine an angle between the rings which depends on the applied torque.

### BRIEF DESCRIPTION OF THE SEVERAL VIEWS OF THE DRAWING

Other objects and advantages of the invention will appear in the following description, made with reference to the appended figures, wherein:

FIG. 1 is a front representation of a test body before fastening the rings according to an embodiment of the invention.

FIG. 1a is a section according to the line A-A of FIG. 1 showing the arrangement of a magnetisation tool with respect to said test body;

FIG. 2 is a front representation of an instrumented test body according to one embodiment of the invention;

FIG. 3 represents in front view the magnetisation of the internal magnetic track of a test body according to the invention.

FIG. 3a is a section according to the line A-A of FIG. 3;

FIG. 4 represents in front view the magnetisation of the external magnetic track of a test body according to the invention.

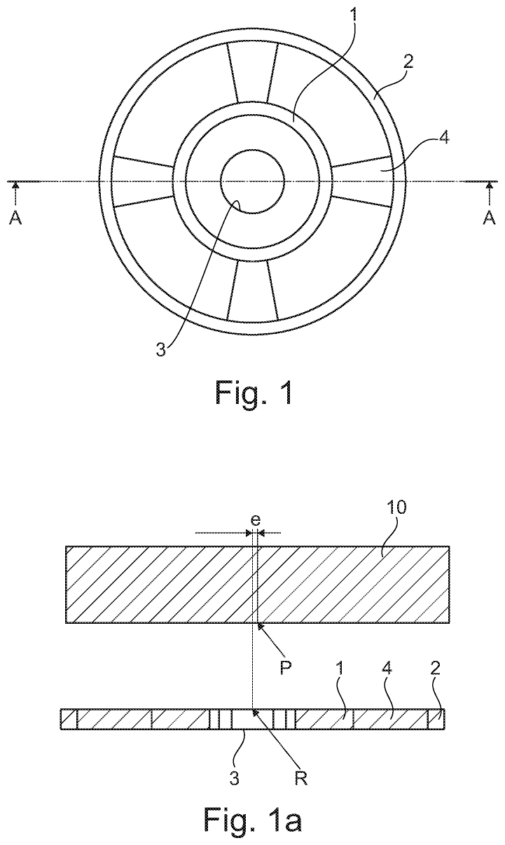

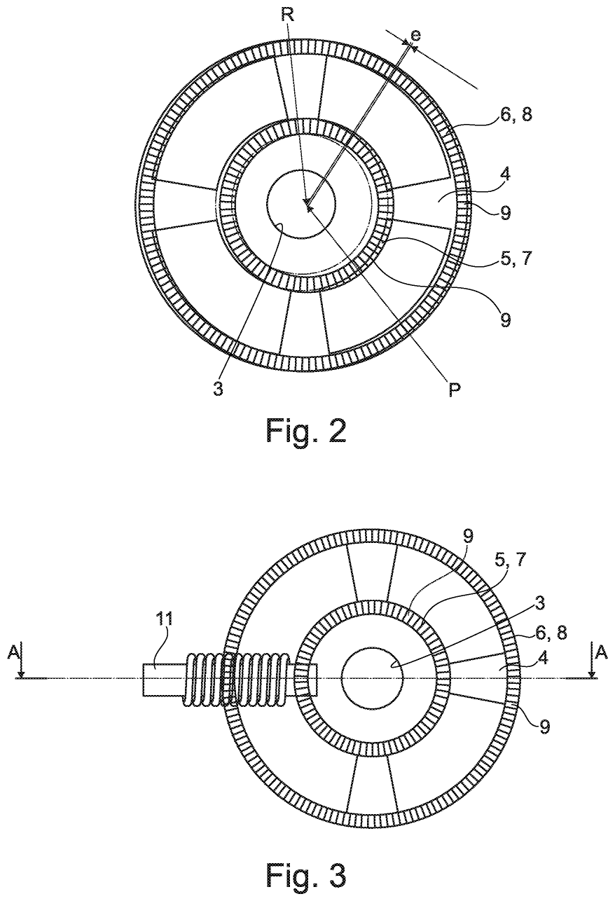

### DETAILED DESCRIPTION OF THE PREFERRED EMBODIMENTS

Referring to these figures, a system for determining a torque applied between two members rotating about a geometric axis of rotation R is described hereinbelow.

In particular, the system enables the determination of a torque applied between two members integrated in a transmission of a motor torque to a vehicle, for example between the electric motor and the mechanical transmission of an electrically power assisted bicycle.

The system comprises a test body having an internal bushing 1 secured in rotation with means for mounting said test body on one member, and an external bushing 2 extending around the internal bushing 1 while having means for mounting said test body on the other member.

The bushings 1, 2 are connected by a deformable structure which is arranged so as to transmit the torque between the members while enabling an angular displacement between said rings according to the torque applied between said members.

In the represented embodiment, the rings 1, 2 are concentric around a mounting sleeve 3 on the geometric axis of rotation R, for example a shaft for transmitting the torque to another shaft on which the external bushing 2 is mounted, the deformable structure comprising at least one radial arm 4—four arms angularly distributed in an even manner in the figures—which connects the bushings 1, 2.

Thus, the torque transmitted between the shafts induces a torsion of the bushings 1, 2 and therefore a relative angular movement of said bushings according to a torsion angle which depends on said torque, the system determining said torque on the basis of the measurement of said torsion angle.

For this purpose, an encoder is made with the test body by equipping each of the bushings 1, 2 respectively with an internal 5 and external 6 ring respectively carrying an internal 7 and external 8 magnetic track which is able to emit a signal, for example a periodic signal, representative of the movement of said rotating ring, the system comprising a sensor for measuring the angular position of each of said rings.

In particular, a succession of respectively Nppᵢ and Nppₑ pairs of North and South poles 9 is magnetised on a ring 5, 6 to form a multipolar magnetic track 7, 8 able to emit a pseudo-sine shaped magnetic signal.

The rings 5, 6 may comprise an annular matrix, for example made based on a plastic or elastomeric material, in which magnetic particles are dispersed, in particular ferrite or rare-earth particles such as NdFeB, said particles being magnetised so as to form the magnetic tracks 7, 8.

The sensor comprises a first—respectively a second—pattern of sensitive elements disposed at a reading distance from the internal track 7—respectively from the external track 8—to form a signal representative of the angular position of the corresponding ring 5, 6.

In particular, each pattern may comprise at least two sensitive elements, in particular a plurality of aligned sensitive elements as described in the documents FR-2 792 403, EP-2 602 593 and EP-2 602 594.

The sensitive elements may be based on a magneto-resistive material whose resistance varies according to the magnetic signal of the track 7, 8 to be detected, for example of the AMR, TMR or GMR type, or a Hall effect probe.

According to one embodiment, the angular position can be determined incrementally by means of the signal emitted by a magnetic track 7, 8. According to another embodiment, the angular position can be determined in an absolute manner, i.e. with respect to a reference position, by providing a secondary magnetic track or a specific coding on the ring 5, 6.

The system further comprises a device for comparing the signals delivered by the sensor, said device being able to determine an angle between the bushings 1, 2 which depends on the applied torque.

According to one embodiment, the sensors deliver incremental square signals in quadrature phase, the comparison device comprising counting means indicating the angular position of each of the rings 5, 6 and subtraction means allowing calculating the difference between said angular positions.

The sensor may comprise means for applying an interpolation factor fᵢ and fₑ to the signal delivered respectively by the first and second pattern of sensitive elements, the counting means measuring a number of fronts nᵢ and nₑ in each of said interpolated signals.

Considering internal 7 and external 8 tracks respectively comprising Nppᵢ and Nppₑ pairs of North and South poles 9, the subtraction means perform for example the operation Nppₑ·fₑ·nᵢ−Nppᵢ·fᵢ·nₑ to calculate the difference between the angular positions of the rings 5, 6.

In particular, the sensor comprises means for applying interpolation factors such that: fₑ/fᵢ=Nppᵢ/Nppₑ. When the tracks 7, 8 have the same number of pairs of poles 9 (Nppᵢ=Nppₑ) and therefore a polar width different from one track 7 to the other track 8, the calculation may be carried out by simple subtraction of the fronts nᵢ and nₑ with a same interpolation factor (fᵢ=fₑ).

According to one embodiment, the number Nppᵢ and Nppₑ of pairs of poles 9 are such that the poles 9 of the tracks 7, 8 have a polar width which is identical, which has the advantage of enabling the use of patterns of sensitive elements with the same configuration and in the same operating conditions. Thus, it is possible to compensate for their magnetic period related errors, for example their non-linearity or other common intrinsic defects.

The method for making the encoder provides for fastening at first the rings 5, 6 on the body, then magnetising each of the magnetic tracks 7, 8 concentrically so that they have a common axis of revolution P.

In the represented embodiment, the rings 5, 6 are fastened before magnetisation thereof respectively on one bushing 1, 2 of the body to form the internal magnetic track 7 and the external magnetic track 8 respectively by subsequent magnetisation.

Advantageously, the method provides for fastening the rings 5, 6 concentrically on the bushings 1, 2 so that they have a common axis of revolution with the geometric axis of rotation R.

Prior fastening enables the rings 5, 6 to have the same mechanical eccentricity which is induced by a possible distance between their centre and the geometric axis of rotation R, and the subsequent magnetisation of the tracks allows obtaining a same magnetic eccentricity e between their common axis of revolution P and the geometric axis of rotation R.

Thus, the eccentricities e being the same, their possible defects do not affect the accuracy of the determination of a torque by comparison of the angular position of each of the rings 5, 6, to the extent that the position error will then be the same and can therefore be eliminated by subtraction.

According to one embodiment, the tracks 7, 8 are magnetised by means of a tool which has two crowns for magnetising respectively one ring 5, 6 fastened on the body, the crowns may advantageously have a geometry similar to the geometry of one ring 5, 6 respectively.

This embodiment allows magnetising the tracks 7, 8 simultaneously while complying with their concentricity in a simple way to the extent that it is imposed by the geometry of the magnetisation crowns.

The magnetisation may be carried out by means of a tool 10 in particular so as to be able to magnetise the rings 5, 6 fastened on the bushings 1, 2 with their magnetic tracks 7, 8 disposed in a plane L, said tracks may include an identical or different number of pairs of poles 9.

According to another embodiment, the tracks 7, 8 are magnetised by means of a tool 11, the body and said tool being mounted in a relative rotatable manner according to the common axis of revolution P. In particular, the tool 11 may be fixed and the body rotatably mounted relative to said tool.

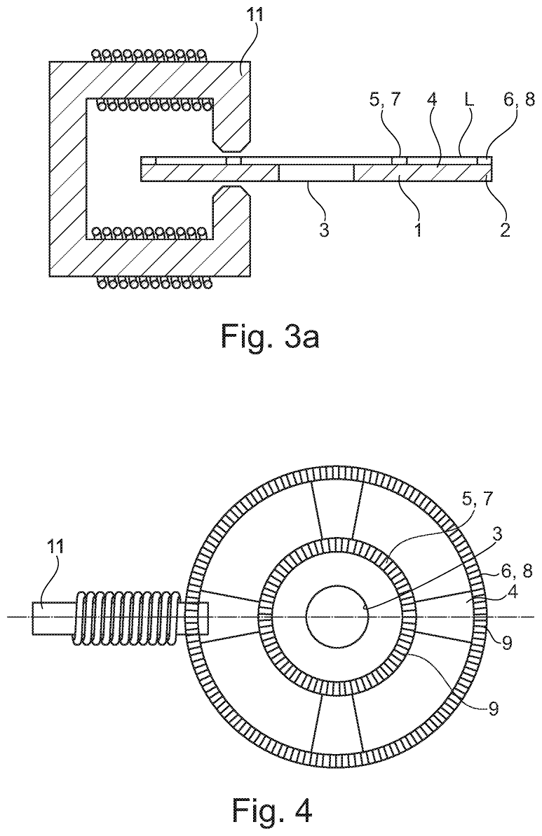

Referring to FIGS. 3 and 4, the method provides for a tool 11 for magnetising a pole 9, a pair of adjacent poles 9 or an angular succession of poles 9, said tool and respectively one ring 5, 6 being moved relative to one another so as to be radially opposite one another to successively magnetise the poles 9 of a track 7, 8 by successive relative rotations of said tool relative to said ring.

What is claimed is:

1. A test body for a system for determining a torque applied between two members rotating about a geometric axis of rotation (R), said test body having an internal bushing secured in rotation with means for mounting said test body on one member, and an external bushing extending around the internal bushing while having means for mounting said test body on the other member, said bushings being connected by a deformable structure which is arranged so as to transmit the torque between the members while enabling an angular displacement between said bushings according to the torque applied between said members, said test body being equipped with two rings each carrying a magnetic track which is able to emit a signal representative of the rotational movement of said ring, the rings (5, 6) being fastened respectively on one bushing and the magnetic tracks being magnetized concentrically so that they have a common axis of revolution (P) so as to respectively form an internal magnetic track and an external magnetic track of an encoder.

2. The test body according to claim 1, the rings having a common axis of revolution with the geometric axis of rotation (R).

3. The test body according to claim 1, the rings being fastened on the body so that their tracks are disposed in a plane (L).

4. The test body according to claim 1, the two rings comprising an annular matrix in which magnetic particles are dispersed, said particles being magnetized so as to form the magnetic tracks.

5. The test body according to claim 1, the deformable structure comprising at least one radial arm which connects the bushings.

6. The test body according to claim 1, the internal and external tracks respectively comprise Nppᵢ and Nppₑ pairs of North and South poles to form the multipolar magnetic tracks.

7. The test body according to claim 6, the numbers Nppᵢ and Nppₑ of pairs of poles are such that the poles of the tracks have a polar width that is identical.

8. A method for making a test body according to claim 1, said method providing for:
fastening the rings respectively on one bushing; then
magnetizing each of the magnetic tracks concentrically so that they have a common axis of revolution (P).

9. The method according to claim 8, the tracks being magnetized simultaneously.

10. The method according to claim 8, the tracks being magnetized by a tool, the test body and said tool being mounted in a relative rotatable manner according to the common axis of revolution (P).

11. The method according to claim 10, a tool for magnetizing one of a group including a pole, a pair of adjacent poles, and an angular succession of poles, said tool and respectively one ring being moved relative to one another so as to be radially opposite one another to successively magnetize the poles of a track by successive relative rotations of said tool relative to said ring.

12. A system for determining a torque applied between two rotating members about a geometric axis of rotation (R), said system comprising a test body according to claim 1 and a sensor comprising a first—respectively a second—pattern of sensitive elements disposed at a reading distance from the internal track—respectively from the external track—to form a signal representative of the angular position of the corresponding ring, said system further comprising a device for comparing the signals delivered by the sensor, said device being able to determine an angle between the rings which depends on the applied torque.

13. The determination system according to claim 12, the sensors delivering incremental square signals in quadrature phase, the comparison device comprising counting means indicating the angular position of each of the rings and subtraction means allowing calculating the difference between said angular positions.

14. The determination system according to claim 13, the sensor comprising means for applying an interpolation factor fᵢ, and fₑ to the signal delivered respectively by the first and second pattern of sensitive elements, the counting means measuring a number of fronts nᵢ and nₑ in each of said interpolated signals, the subtraction means performing the operation Nppₑ·fₑ·nᵢ−Nppᵢ·fᵢ·nₑ to calculate the difference between the angular positions of the rings.

15. The determination system according to claim 14, the sensor comprising means for applying interpolation factors such that: fₑ/fᵢ=Nppᵢ/Nppₑ.
